(19) United States
(12) Patent Application Publication
(10) Pub. No.: US 2006/0061810 A1
(43) Pub. Date: Mar. 23, 2006

(54) Apparatus and method for adding an image of a multimedia message to a phonebook of a portable wireless terminal

(75) Inventors: A-Ram Choi, Seoul (KR); Jeong-Gyu Jin, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/225,634

(22) Filed: Sep. 13, 2005

(30) Foreign Application Priority Data
Sep. 23, 2004 (KR) 2004-0076232

(51) Int. Cl. G06F 3/12

(52) U.S. Cl. 358/1.15

(57) ABSTRACT

An apparatus and method for automatically adding a received image to a phonebook of a portable wireless terminal. In the method, an image is extracted from a received multimedia message when the multimedia message is received from a sender, the extracted image is added to a sender's image list of a phonebook, and an image most recently added to the sender's image list is read out and displayed when a call is received from the sender. Therefore, the latest image of the sender can be displayed when a call is received from the sender.

This application claims priority under 35 U.S.C. § 119 to an application entitled “Apparatus and Method for Adding Image of Multimedia Message into Phonebook in Portable Wireless Terminal” filed in the Korean Intellectual Property Office on Sep. 23, 2004 and assigned Serial No. 2004-0076232, the contents of which are incorporated herein by reference.

### BACKGROUND OF THE INVENTION

1. Field of the Invention

The present invention relates generally to an apparatus and method for registering an image of a multimedia message in a phonebook of a portable wireless terminal, and more particularly, to an apparatus and method for adding an image extracted from a received multimedia message to a sender's image list of a phonebook.

2. Background of the Prior Art

As a variety of electronic and communication industries advance, portable wireless terminals are becoming more widely distributed. Functions of the terminals are becoming more diversified to meet growing user demands. Additionally, these terminals tend to be small-sized and lightweight. For example, with the introduction of a portable wireless terminal having a built-in digital camera, desired objects can be easily captured and stored. Also, the captured images can be uploaded on a wireless Internet server and transmitted to other terminals.

In the portable wireless terminal, short message service (SMS) and phonebook functions are most widely used. Further, the SMS is changing into a multimedia messaging service (MMS) that can transmit a message having an image attached thereto. Therefore, a phonebook in which images, e.g., pictures and emoticons, can be registered has been introduced. This is commonly referred to as a “photo phonebook”. That is, the phonebook has been developed from the simple phone number storing feature to the image storing feature.

When wireless terminal users take pictures or receive multimedia messages having images, the users must manually register the images one by one in the phonebook of the wireless terminal. This manual registration can be a tedious and troublesome task to the users, thereby causing great user inconvenience.

One function of the photo phonebook is to enable a sender (or caller) image to be displayed on a recipient terminal when a call is received, in order to allow the recipient to identify the sender. However, the conventional photo phonebook is constructed to store only one image in each phonebook entry, i.e., a previously saved image must be deleted to save a new image. This may cause the user to hesitate to save a new image and therefore an old image instead of a recent image may be displayed when a call is received, such that the image display function for notifying the recipient of the sender cannot be carried out effectively.

### SUMMARY OF THE INVENTION

The present invention provides an apparatus and method for automatically updating a registered image in a phonebook of a portable wireless terminal.

Also, the present invention provides an apparatus and method for automatically adding an image received through a multimedia message to a phonebook of a portable wireless terminal.

Further, the present invention provides an apparatus and method for managing image lists with respect to senders, by using a phonebook.

Further, the present invention provides an apparatus and method for a portable wireless terminal, in which an image received through a multimedia message is added to a phonebook, the added image is stored in a photo album together with sender information, and images in the photo album can be searched with respect to senders.

According to an aspect of the present invention, a method of automatically adding a received image to a phonebook of a portable wireless terminal, includes: when a multimedia message is received from a sender, extracting an image from the received multimedia message; adding the extracted image to a sender's image list of a phonebook; and when a call is received from the sender, reading the latest image from the sender's image list and displaying the latest image.

After adding the extracted image to the sender's image list, the method may further include storing the added image in a photo album together with sender information, such that images in the photo album can be searched with respect to the sender.

### BRIEF DESCRIPTION OF THE DRAWINGS

The accompanying drawings, which are included to provide a further understanding of the present invention and are incorporated in and constitute a part of this application, illustrate embodiment(s) of the invention and together with the description serve to explain the principle of the invention. In the drawings:

FIG. 1 is a block diagram of a portable wireless terminal according to an embodiment of the present invention;

FIG. 2 is a flowchart illustrating a method for adding an image in a received multimedia message to a phonebook of a portable wireless terminal according to an embodiment of the present invention;

FIG. 3 is a flowchart illustrating a method for searching images with respect to senders in a portable wireless terminal according to an embodiment of the present invention; and

FIG. 4 illustrates exemplary screens to be sequentially displayed when a photo album search is performed according to the present invention.

### DETAILED DESCRIPTION OF THE PREFERRED EMBODIMENTS

Reference will now be made in detail to preferred embodiments of the present invention, examples of which are illustrated in the accompanying drawings. Also, when it is determined that the subject of the invention may be ambiguous by a detailed description thereof, the detailed description will be omitted.

Hereinafter, an apparatus and method for adding an image extracted from a received multimedia message to a sender's image list of a phonebook in a portable wireless terminal will be described. An apparatus and method for saving the added image and sender's information in a photo album and searching the saved image with respect to sender will also be described below. Herein, the phonebook may also be termed a photo phonebook because of its image management ability.

The term “multimedia message” is used to denote any kind of message having an image, for example, a multimedia messaging service (MMS) message, an e-mail message, an enhanced messaging service (EMS) message, etc. Also, the multimedia message includes a message serviced in a manner such that Internet link information is sent to a recipient and the recipient uses that information to download a corresponding image from a WEB server.

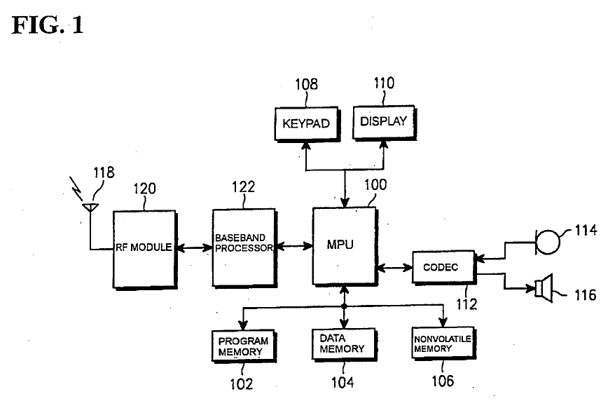

FIG. 1 is a block diagram of a portable wireless terminal according to an embodiment of the present invention. The portable wireless terminal includes a cellular phone, a personal communication system (PCS) terminal, a personal data assistant (PDA), an international mobile communication-2000 (IMT-2000) terminal, a 4G (OFDM: orthogonal frequency division multiplexing) terminal, etc. Accordingly, the following descriptions will be made with a general structure of the above terminals.

Referring to FIG. 1, a microprocessor unit (MPU) 100 controls an overall operation of the terminal. For example, the MPU 100 processes and controls voice communication and data communication. In addition to the typical functions, the MPU 100 controls the process of automatically adding an image extracted from a received multimedia message to a phonebook entry and a photo album. The typical process and control operations of the MPU 100 are well known in the art and are described here in sufficient detail to aid understanding the present invention.

A memory includes a program memory 102, a data memory 104, and a nonvolatile memory 106. The program memory 102 stores a program for controlling an overall operation of the terminal. A flash memory may be used as the program memory 102. The data memory 104 temporarily stores data that is created during the operation of the terminal. A random access memory (RAM) may be used as the data memory 104. The nonvolatile memory 106 stores system parameters and other data (phone number, SMS message, image data, etc.). An electrically erasable and programmable read only memory (EEPROM) may be used as the nonvolatile memory 106. Photo phonebook data and photo album data may be stored in the data memory 104 or the nonvolatile memory 106.

A keypad 108 includes common Numeric keys of digits 0-9 and a plurality of Function keys, such as a Menu key, a Cancel (Delete) key, a Confirmation key, a Talk key, an End key, an Internet connection key, and Navigation keys (▴/▾/ [symbol] / [symbol] ). Pressing the keypad 108 creates corresponding key input data, which is transmitted to the MPU 100. A display 110 displays status information (or indicator) of the terminal, numerals and characters, moving pictures and still pictures, etc. A color liquid crystal display (LCD) may be used as the display 110.

A coder-decoder (CODEC) 112 connected to the MPU 100, a speaker 116 connected to the CODEC 112, and a microphone 114 connected to the CODEC 112 are an audio input/output block that is used for a voice communication. The MPU 100 produces PCM data and the CODEC 112 converts the PCM data into analog audio signals. The analog audio signals are output through the speaker 116. Also, the CODEC 112 converts audio signals received through the microphone 114 into PCM data and provides the PCM data to the MPU 100.

A radio frequency (RF) module 120 decreases the frequency of an RF signal received through an antenna 118 and provides the RF signal to a baseband processor 122. The RF module 120 increases the frequency of a baseband signal provided from the baseband processor 122 and transmits the baseband signal via the antenna 118. The baseband processor 122 processes the baseband signals that are transmitted/received between the RF module 120 and the MPU 100. For example, during data transmission, the baseband processor 122 performs a channel coding and spreading on the transmission data. During data reception, the baseband processor 122 performs a despreading and channel decoding on the reception data.

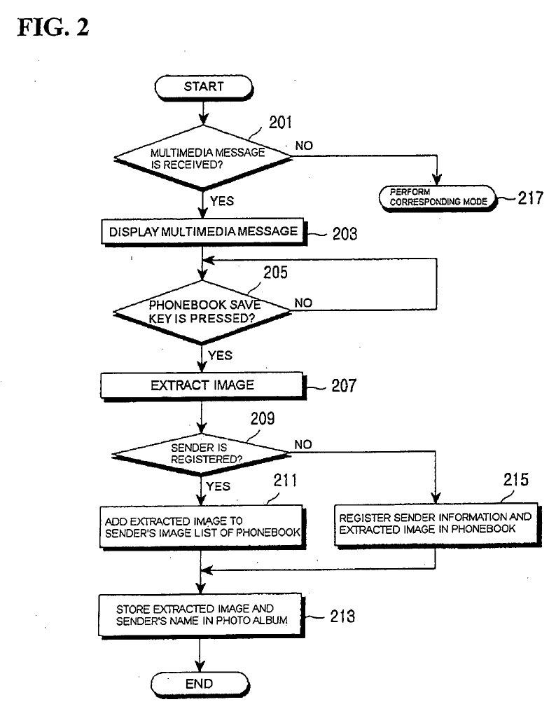

FIG. 2 is a flowchart illustrating a method for automatically adding an image in a received multimedia message to a phonebook of a portable wireless terminal according to an embodiment of the present invention. Referring to FIG. 2, in step 201, the MPU 100 determines if a multimedia message is received. If no message is received, the MPU 100 proceeds to step 217 to perform a corresponding mode, e.g., a hold mode. If the multimedia message is received, in step 203, the MPU 100 searches a message sender's name from phonebook entries using a sender's phone number included in a header of the received multimedia message, and displays the received multimedia message and the sender's name in a window.

The multimedia message, as described above, includes a message having an image and a SMS message having Internet link information to enable a recipient to download an image uploaded on a web server by a sender. In case the SMS message with the Internet link information is received, step 201 may check the SMS message and operation 203 may search the image from the web by using the Internet link information.

In step 205, the MPU 100 determines if a Phonebook save key is pressed and if a key is pressed, proceeds to step 207 to extract an image from the received multimedia message.

In step 209, the MPU 100 determines if a sender's entry exists in the phonebook. If the sender's entry does not exist, the MPU 100 proceeds to step 215 to register sender's information in the phonebook. For example, the MPU 100 displays a phonebook registration screen including the extracted image and sender's phone number in a window, and receives additional sender's information such as name, home telephone number, and e-mail address from the user. The MPU 100 registers the information of the phonebook registration screen in a sender's entry of the phonebook when the user pressed a Confirmation key. Thereafter, the MPU 100 proceeds to step 213.

However, if the sender's entry exists in a phonebook, the MPU 100 proceeds to step 211 to add the extracted image to an image list of the sender's phonebook entry. Herein, when the extracted image cannot be added to the sender's image list owing to storage capacity, the MPU 100 may offer user the deletion of a previously stored image or automatically delete the oldest image in the image list to add the extracted image. Thereafter, the MPU 100 proceeds to step 213. In step 213, the image and sender's name registered or added in the phonebook at step 211 or 215 are saved in a photo album. Thereafter, the processing is terminated.

In the embodiment described above, the image registration in the phonebook is performed upon receipt of a user input, e.g., user's keystroke. The image registration may be also performed automatically without the user's keystroke when the multimedia message is received.

For a portable wireless terminal having a phonebook, when a call is received, a sender's image as registered in the phonebook is read out and displayed in a window. In the present invention, when a call is received, the sender's latest image can be displayed, because a plurality of images from the first to the latest one are managed.

Further, according to the present invention, because the phonebook images are registered in the photo album together with the sender's information (e.g., a name and a phone number), the images of the photo album can be searched with respect to each sender. Further, a folder having a selected sender's information may be made in the photo album to store a history information and images, such that the stored image can be sorted and displayed when the user selects a photo album display menu. Hereinafter, a method of searching images in the photo album with respect to each sender will be described in detail.

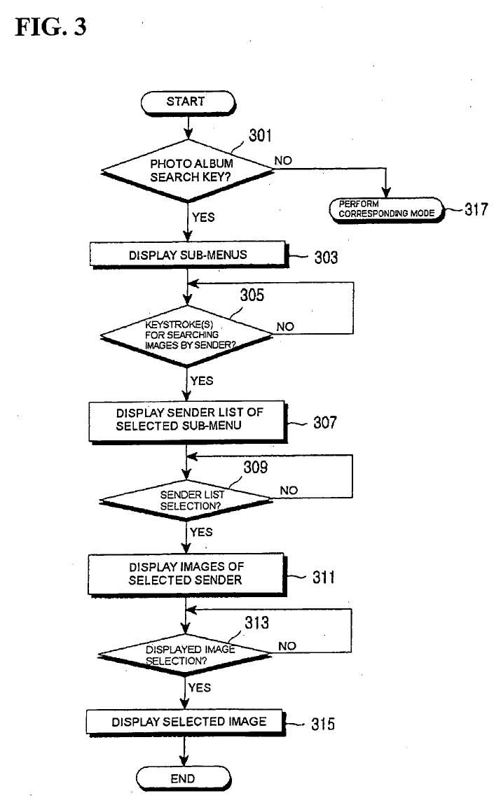

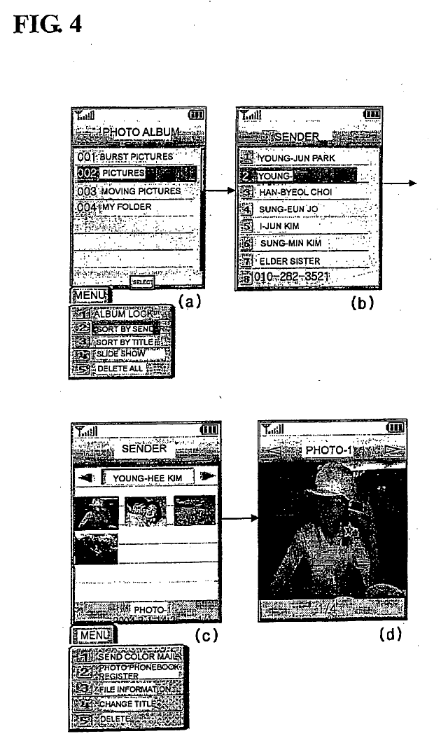

FIG. 3 is a flowchart illustrating a method for searching images with respect to senders in a portable wireless terminal according to an embodiment of the present invention. Referring to FIG. 3, in step 301, the MPU 100 determines if a Photo album search key is pressed. If no Photo album search key is pressed, the MPU 100 proceeds to step 317 to perform a corresponding mode, e.g., a hold mode. If the Photo album search key is pressed, the MPU 100 proceeds to step 303 to display photo album sub-menus (i.e., folders storing images). For example, in FIG. 4, screen (a) shows such sub-menus.

In step 305, the MPU 100 determines if there is a key manipulation to search images with respect to the sender. If there is a key manipulation to search images, the MPU 100 proceeds to step 307 to display a sender list of a selected sub-menu. For example, in FIG. 4, screen (b) shows a sender list of the selected image sub-menu. That is, the images in the photo album can be sorted according to the senders. This sorting is possible because the images received through the multimedia messages are saved in the photo album together with the sender's information.

In step 309, the MPU 100 determines if the user selects one sender among the sender list. If a sender is selected, the MPU 100 proceeds to step 311 to display images that have been received from the selected sender, as is shown in screen (c) of FIG. 4.

In step 313, the MPU 100 determines if the user selects one of the displayed images. If a displayed image is selected, the MPU 100 proceeds to step 315 to display the selected image in an enlarged scale, as is shown in screen (d) of FIG. 4.

As described above, in the present invention the multimedia message reception and the phonebook registration are associated, such that user's inconvenience of manually updating an image in the phonebook can be eliminated. Additionally, the phonebook manages the images from the first one to the last one, such that the phonebook can use the history information of the saved images to display the most recently stored image of sender when a call is received from the image sender. Further, the images received through the multimedia message are stored in the photo album together with the sender's information, such that the user can search the saved images with respect to each sender.

The forgoing embodiments are merely exemplary and are not to be construed as limiting the present invention. The present teachings can be readily applied to other types of apparatuses. The description of the present invention is intended to be illustrative, and not to limit the scope of the claims, i.e., many alternatives, modifications, and variations will be apparent to those skilled in the art.

What is claimed is:

1. A method of automatically adding a received image to a phonebook of a portable wireless terminal, comprising:
receiving a multimedia message from a sender;
extracting an image from the received multimedia message; and
adding the extracted image to a sender's image list of a phonebook.

2. The method of claim 1, wherein the multimedia message is selected from a group consisting of an MMS (Multimedia Message Service) message, an E-mail message, and an EMS (Enhanced Messaging Service) message.

3. The method of claim 1, further comprising:
receiving a call from the sender;
reading out a latest image from the sender's image list; and
displaying the latest image in a window of the portable wireless terminal.

4. The method of claim 1, further comprising:
storing the added image in a photo album together with a sender's information in order to enable an image search in the photo album with respect to the sender.

5. The method of claim 1, further comprising:
automatically registering the extracted image and a phone number of the sender in the phonebook, if the sender is not registered in the phonebook.

6. The method of claim 1, wherein the phonebook provides a photo album function for displaying a sender's information and at least one image according to the sender's image list.

7. A method of automatically adding a received image to a phonebook of a portable wireless terminal, comprising:
displaying a multimedia message received from a sender;
determining if a phonebook save key is pressed;
if the phonebook save key is pressed, extracting an image from the received multimedia message; and
adding the extracted image to a sender's image list registered in a phonebook.

8. The method of claim 7, wherein the multimedia message is selected from a group consisting of an MMS (Multimedia Message Service) message, an E-mail message, and an EMS (Enhanced Messaging Service) message.

9. The method of claim 7, further comprising:
receiving a call from the sender;
reading out a latest image from the sender's image list; and
displaying the latest image in a window of the portable wireless terminal.

10. The method of claim 7, further comprising:
storing the added image in a photo album together with a sender's information in order to enable an image search in the photo album with respect to the sender.

11. The method of claim 7, wherein the phonebook provides a photo album function for displaying a sender's information and at least one image according to the sender's image list.

12. An apparatus for automatically adding a received image to a portable wireless terminal, comprising:
a phonebook for registering a plurality of images;
a display for displaying a multimedia message when the multimedia message is received from a sender; and
an MPU (microprocessor unit) for extracting an image from the received multimedia message and accessing the phonebook to add the extracted image to a sender's image list of the phonebook.

13. The apparatus of claim 12, wherein when a call is received from the sender, the MPU reads out a latest image from the sender's image list and displays the latest image in a window of the portable wireless terminal.

14. The apparatus of claim 12, further comprising a photo album for searching images with respect to senders, wherein the MPU stores an added image of the phonebook in the photo album together with a sender's information.

15. The apparatus of claim 12, wherein the multimedia message is selected from a group consisting of an MMS (Multimedia Message Service) message, an E-mail message, and an EMS (Enhanced Messaging Service) message.

16. The apparatus of claim 12, wherein the phonebook provides a photo album function for displaying a sender's information and at least one image according to the sender's image list.
